(19) United States
(12) Patent Application Publication
(10) Pub. No.: US 2017/0159873 A1
(43) Pub. Date: Jun. 8, 2017

(54) MONITOR STAND

(71) Applicant: Meerkat Desk Ltd, Auckland (NZ)

(72) Inventor: Alice FARRELL, Auckland (NZ)

(21) Appl. No.: 15/370,609

(22) Filed: Dec. 6, 2016

(30) Foreign Application Priority Data
Dec. 7, 2015 (NZ) 714937

(51) Int. Cl. F16M 11/04; F16M 11/10; A47B 97/00; F16M 13/02

(52) U.S. Cl. CPC F16M 11/046; F16M 13/022; F16M 11/10; A47B 97/00; F16M 2200/022; F16M 2200/028; A47B 2097/005

(57) ABSTRACT

The invention relates to a monitor stand. Preferred embodiments are suited to providing height adjustment of a video screen above a work surface. The stand has an outer rod 2 and an inner rod 3. A handle 4 can be moved up and down within the outer rod 2 to move the inner rod 3 in corresponding fashion. The inner rod 3 can be locked at a selection of heights by turning a clasp 8 of the handle into one or other of a series of slots 6 in the outer pole. A connector 5 adapted to receive a video screen is secured to the inner pole so as to be height adjustable with the inner pole 3.

### FIELD OF INVENTION

This invention relates to a monitor stand. A preferred embodiment of the invention relates an adjustable stand for use with computer monitors.

### BACKGROUND

It is known to use video monitors for a wide range or purposes and in a wide range of applications. It is for example desirable to mount a monitor to a desk or bench so that it is elevated above a work surface. In some situations the monitor is used by different people at different times, and as is often the case each person has a different height. While having the monitor at a particular height may be suitable for one person, it may be less than optimal for someone who is taller or shorter. It is accordingly an object of a preferred embodiment of the invention to go at least some way towards addressing this problem. While this object applies to the preferred embodiment it should not be seen as a limit on the claims. The object of the invention per se is simply to provide the public with a useful choice.

### DEFINITION(S)

The term “comprising” or variations thereof if used in relation to a number of features should not be taken to exclude the possibility of other non-listed features. Other features may or may not be present. The term should therefore be interpreted in a non-limiting manner.

### SUMMARY OF THE INVENTION

According to one aspect of the invention there is provided a stand for a video monitor, comprising:
an inner rod;
an outer rod;
a handle; and
a connector adapted for attachment to a video monitor;
   the handle being associated with the inner rod such that up and down movement of the handle causes the inner rod to move correspondingly within the outer rod, the outer rod having a series of slots and the handle being able to turn to selectively engage one or another of the slots and, when so engaged, to lock the inner rod at a selected height, the connector being associated with the inner rod so that adjustment of the inner rod causes the height of the connector to be adjusted.

Optionally the slots are downwardly angled.

Optionally the inner rod sits on the handle.

Optionally the outer rod has a vertically running slot which opens the front face of the outer rod.

Optionally the inner rod is separate to the handle.

Optionally the inner rod is integral with the handle.

Optionally the handle has a hand-clasp which can turn (eg through approximately) 90° into and out of each of the slots.

Optionally the hand-clasp can be selectively moved up and down along the vertically running slot of the outer rod.

Optionally the stand has a clamp adapted to enable it to fasten to a work station such that the rods are held upright.

Optionally the connector has a pivot mechanism adapted to enable angle adjustment of a video monitor if attached to the connector.

Optionally the connector comprises a plate with apertures for receiving fasteners to attach to a video monitor when in use.

### DRAWINGS

Some preferred embodiments of the invention will be described below by way of example and with reference to the accompanying drawings, of which:

FIG. 1 is a front isometric view of a stand for a video monitor;

FIG. 2 is an isometric view of the stand from behind;

FIG. 3 is an isomeric view of the stand showing detail of its lower end;

FIG. 4 is a front elevation view of the stand;

FIG. 5 is a side elevation view of the stand;

FIG. 6 is a top plan view of the stand; and

FIG. 7 is a bottom plan view of the stand.

### DETAILED DESCRIPTION

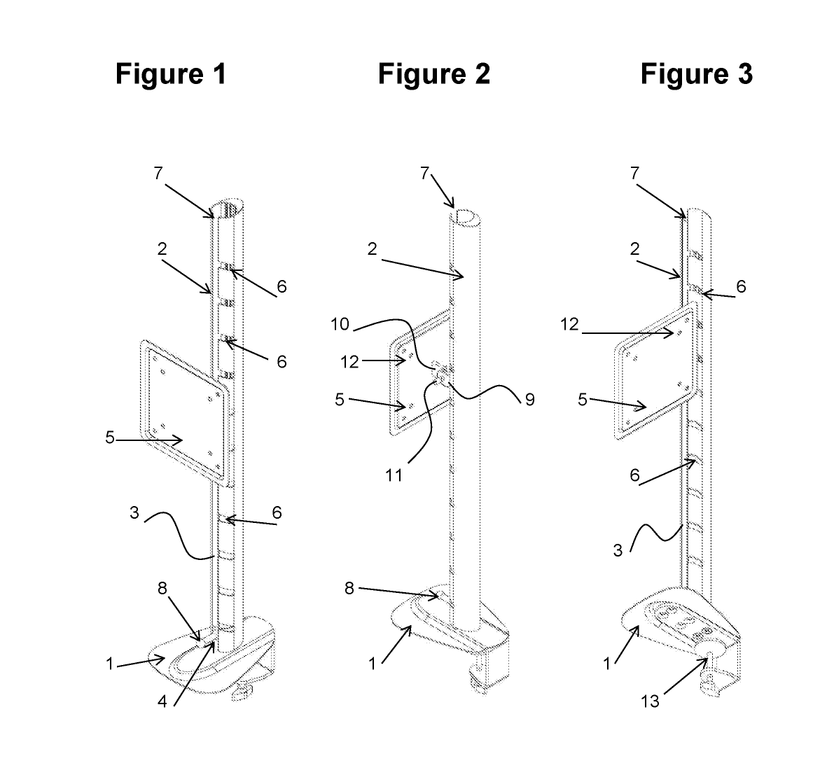

Referring to FIGS. 1, 2 and 3, the monitor stand has a base 1, a rod in the form of an outer pole 2, a shorter rod in the form of an inner pole 3, a locking handle 4 and a screen connector 5. The outer pole 2 provides a sleeve for both the inner pole 3 and the handle 4, and has a series of downwardly angled side slots 6. The inner pole 3 sits on the handle 4 and both can slide up and down within the outer pole 2. The inner pole 3 may or may not be hollow.

As shown in FIG. 1, the front face of the outer pole 2 is open with a vertical slot 7 running from top to bottom. A clasp 8 of the handle protrudes outwards from the vertical slot and can, if desired, be pulled on by hand to move up and down the vertical slot 7. When the clasp 8 is in line with one of the side slots 6 it can be turned backwards through about 90° to enter that slot, and then released. While in the slot 6 the clasp 8 effectively locks the handle at that height. However turning the clasp 8 back through 90° causes it to re-enter the vertical slot 7 and therefore frees it to be moved up or down again.

Because the inner pole sits 3 on the handle 4, when the handle moves upwards it takes the inner pole with it. And of course when the handle's clasp 8 is locked into one of the side slots 6 the inner pole 3 is locked at the same height. When the clasp 8 moves back into the vertical slot 7 then, unless held there by hand, gravity causes the handle 4 and the inner pole 3 to slide downwards. The handle 4 can therefore be used to selectively adjust the height of the inner pole 3.

Because the screen connector 5 is attached to an upper part of the inner pole 3, when that pole is height adjusted then the connector, and a video screen (not shown) releasably attached to it, are correspondingly adjusted. As will be appreciated, when a screen is fixed to the monitor stand it may take two hands to height adjust it, one to take the weight of the screen and the other to move the handle 4.

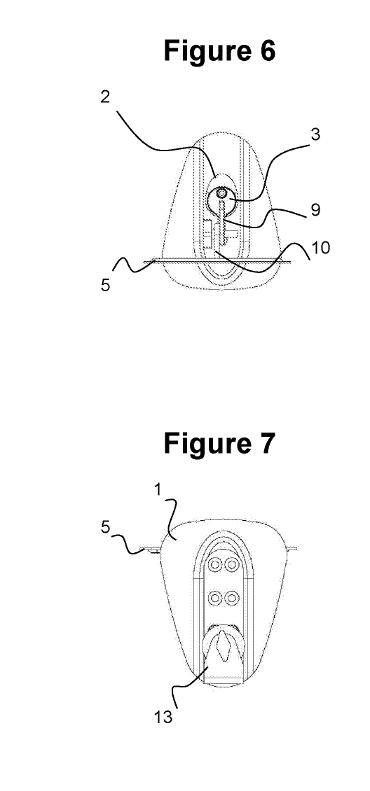

Referring to FIGS. 2 and 6, a pivot mechanism joins the inner pole 3 and the screen connector 5. More specifically, a lug 9 of the pole 3 extends outwards from the vertical slot and connects to a lug 10 of the connector by way of a screw fastener 11. The fastener holds the lugs in pivoting relationship so that the connector 5 can be angle adjusted. This is achieved by loosening the fastener 11, adjusting the angle between the lugs 9, 10, and then tightening the fastener again to lock the lugs at their new angle. The connector 5 has a series of screw holes 12 to enable it to be secured to a computer screen or other monitor.

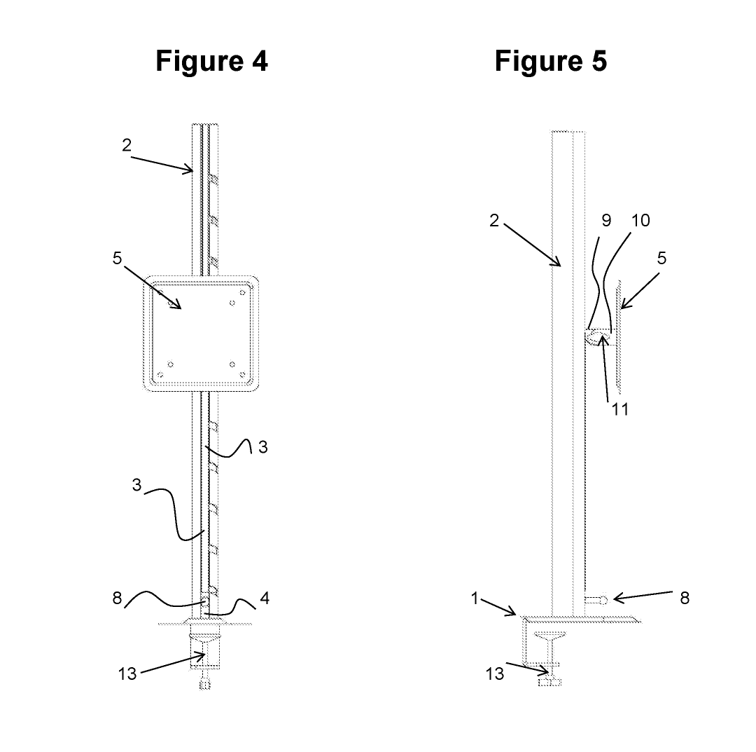

Referring to FIGS. 3, 4, 5 and 7, the base 1 has a screw clamp mechanism 13 suitable for engaging with a desk or other work surface so that the two poles 2, 3 extend vertically and the connector 5 can receive a monitor. The mechanism can be tightened and loosened by hand.

In particularly preferred embodiments of the invention the monitor stand is formed to enable screen height adjustment through a range of about 51 cm. Preferably the point where the lugs 9, 10 engage can be set at anywhere between 35 cm and 86 cm above a work surface when the stand is clamped thereto. The outer and inner poles 2, 3 may be formed from aluminium extrusions, and the base 1 and connector 5 may be predominantly formed from pressed steel. The handle 4 and lugs 9, 10 may be formed from die-cast zinc containing materials. However these materials are only mentioned as examples and should not be seen as a limitation on the invention.

While some preferred embodiments of the invention have been described by way of example it should be appreciated the modifications and improvements can occur without departing from the scope of the following claims.

1. A stand for a video monitor, comprising:
an inner rod;
an outer rod;
a handle; and
a connector adapted for attachment to a video monitor;
the handle being associated with the inner rod such that up and down movement of the handle causes the inner rod to move correspondingly within the outer rod, the outer rod having a series of slots and the handle being able to turn to selectively engage one or another of the slots and, when so engaged, to lock the inner rod at a selected height, the connector being associated with the inner rod so that adjustment of the inner rod causes the height of the connector to be adjusted.

2. A stand according to claim 1, wherein the slots are downwardly angled.

3. A stand according to claim 2, wherein the inner rod sits on the handle.

4. A stand according to claim 3, wherein the outer rod has a vertically running slot which opens the front face of the outer rod.

5. A stand according to claim 4, wherein the inner rod is separate to the handle.

6. A stand according to claim 5, wherein the handle has a hand-clasp which can turn into and out of each of the slots.

7. A stand according to claim 6, wherein the hand-clasp can turn through approximately 90° into and out of each of the slots.

8. A stand according to claim 7, wherein the hand-clasp can be selectively moved up and down along the vertically running slot of the outer rod.

9. A stand according to claim 8, comprising a clamp adapted to fasten the stand to a work station such that the rods are held upright.

10. A stand according to claim 9, wherein the connector has a pivot mechanism adapted to enable angle adjustment of a video monitor if attached to the connector.

11. A stand according to claim 10, wherein the connector comprises a plate with apertures for receiving fasteners to attach to a video monitor when in use.

12. A stand for a video monitor, comprising:
a locking handle;
an inner rod sitting on the locking handle;
an outer rod in the form of a sleeve with an open front face; and
a screen connector secured to a display screen;
the handle being associated with the inner rod such that up and down movement of the handle causes the inner rod to move correspondingly within the outer rod, the outer rod having a series of downwardly angled slots extending from the open front face of the sleeve and the handle being able to turn to selectively engage one or another of the slots and, when so engaged, to lock the inner rod at a selected height, the connector being associated with the inner rod so that adjustment of the inner rod causes the height of the connector and the screen to be adjusted.
